(19) United States
(12) Patent Application Publication
(10) Pub. No.: US 2016/0246985 A1
(43) Pub. Date: Aug. 25, 2016

(54) LICENSING OF SOFTWARE PRODUCTS

(71) Applicant: SIEMENS AKTIENGESELLSCHAFT, Munchen (DE)

(72) Inventors: Alexander BURKHARDT, Bad Liebenzell (DE); Benjamin MAY, Renningen (DE)

(73) Assignee: SIEMENS AKTIENGESELLSCHAFT, Munchen (DE)

(21) Appl. No.: 15/051,874

(22) Filed: Feb. 24, 2016

(30) Foreign Application Priority Data
Feb. 25, 2015 (EP) 15156554.6

(51) Int. Cl. G06F 21/62; G06F 21/10; G06F 21/64

(52) U.S. Cl. CPC G06F 21/6218; G06F 21/64; G06F 21/105

(57) ABSTRACT

In a method for issuing an access authorization for a software product provided on an application server, provision is made for a license server to establish, electronically sign and transfer a license token to the application client, which transmits the license token to the application server. Since the application client supplies its access authorization for access to the software product with the request for the software product, a rapid and efficient checking of the access authorization is possible, even without a connection between the license server and the application server during the request.

### CROSS-REFERENCES TO RELATED APPLICATIONS

This application claims the priority of European Patent Application, Serial No. 15156554.6, filed Feb. 25, 2015, pursuant to 35 U.S.C. 119(a)-(d), the disclosure of which is incorporated herein by reference in its entirety as if fully set forth herein.

### BACKGROUND OF THE INVENTION

The present invention relates to a method for issuing an access authorization for a software product provided on an application server and to a corresponding computer system for implementing the method.

The following discussion of related art is provided to assist the reader in understanding the advantages of the invention, and is not to be construed as an admission that this related art is prior art to this invention.

Several methods are known that enable an application client to access a software product provided on an application server, with the application client and the application server being connected to one another by way of a network. For instance, to issue an access authorization, it may be necessary to enter a key, generally in the form of a specific character string, in the application client. The disadvantage of this approach is that the information relating to a valid key must be known to the application client.

A further possibility involves the physical transmission of the license key to a storage medium of the application client, which was copy-protected by complex technical measures.

Moreover, it is known that when an application client requests a software product provided on an application server, the application server firstly assumes contact with a license server by way of the network and queries whether a license exists for the relevant application client and the relevant software product. Also known is the use of a hardware dongle to the application client, with the dongle usually containing the license key and, optionally, the code required to verify the license.

The interconnection of a license server is advantageous in that in order to check the access authorization, there is no need for direct contact between the application server and the application client.

It would therefore be desirable and advantageous to facilitate issuance of an access authorization of an application client for a software product provided on an application server using a license server, and to obviate other prior art shortcomings.

### SUMMARY OF THE INVENTION

According to one aspect of the present invention, a method for issuing an access authorization for a software product provided on an application server, includes requesting a software product by an application client, requesting at least one license required for access to the software product from the application client by the application server, requesting a required license from a license server by the application client, establishing an electronically signed license token by the license server, transferring the license token signed electronically by the license server to the application client, transferring the electronically signed license token from the application client to the application server, checking the license token transferred and electronically signed by the application server, and in the presence of a valid license, issuing the access authorization for the access of the application client to the software product.

To date, prior to accessing a software product provided on the application server, an application server had to check whether an access authorization existed. To this end, the existence of a license in a license server was generally either checked by a corresponding query from the license server or a check was carried out to determine whether a required license is provided on a local storage medium of the application client with copy protection.

Contrary to this, the invention provides that when an application client requests a software product provided on an application server, the application server firstly informs the application client about the license which is required for the planned access. The application client hereupon requests the required license via the network from a license server. The license server establishes in turn a so-called license token, which shows whether and, optionally, which license the application client has in respect of the software product provided on the application server. To ensure that the application server has the capability to check the correctness of the license token, the license server provides the license token with an electronic signature and transfers it to the application client. The application client in turn transfers the electronically signed license token to the application server. On the basis of the electronic signature, the application server can check the authenticity of the transferred license token and in the case of a valid license can issue the application client with the access authorization for access to the software product provided.

The method according to the present invention is advantageous because it is not the application server that has to request the existence of a valid license from the license server, but instead it is the application client itself that supplies the required license information. To check the license, the application server therefore does not need to have direct access to the license server. Also, complex processes for storing and transmitting non-copyable license key data need not be. implemented.

The license tokens established by the license server are advantageously only valid for a short time, so that misuse can thus virtually be ruled out.

According to another advantageous feature of the present invention, the license server for the electronic signature of the license token can use a secret signature key and the application server can verify the authenticity of the license token through use of a public signature key of the license server. It is thus possible for the application server to be able to trust the origin of the license.

According to another advantageous feature of the present invention, the public signature key of the license server together with the electronically signed license token can be transmitted from the license server via the application client to the application server. This also contributes to a connection between the license server and the application server not being required in order to check the access authorization.

According to another advantageous feature of the present invention, the presence of several application servers is conceivable, wherein the request of the application client can be directed at a first application server, the requested software product can be stored on a second application server. In this case, the request of the software product can be firstly forwarded from the first application server to the second application server. The second application server can respond with the license required for access to the relevant software product and request this from the first application server. The first application server can forward in turn the request for the required license to the application client, which passes the license request on to the license server. The license server can then pack the information relating to the license of the application client in respect of the relevant software product into a license token, provides this with an electronic signature and transfers it via the application client and the first application server to the second application server. This chain may, of course, be extended analogously to more than two application servers. The advantage of the method according to the present invention is the capability to pass the license token in a simple manner in the described manner to the last application server in the chain. On the basis of the supplied signature, the last application server in the chain is thus also capable to verify the correctness of the supplied license token.

According to another advantageous feature of the present invention, a “trust relationship” can be established once between the license server and the application server or the application servers. This can take place advantageously when the license information of the application server in respect of the software product is stored in the license server. This takes place advantageously prior to a first request for the software product by an application client. The trust relationship can be established for instance in that the license server transmits its public signature key to the application server. This creation of a trust relationship prior to querying an access authorization in the form of a license is advantageous in that with a subsequent request for an access authorization, a connection between the license server and the application server is no longer required.

According to another advantageous feature of the present invention, the software product can be a web service. A web service involves hereby a software application, which is provided for direct machine-to-machine interaction by way of a network. Web services are frequently accessed at the same time by a number of application clients and at short time intervals. For the application server, on which a relevant web service is provided, this therefore means significantly less work, when, with each request, the information relating to a valid license is also supplied.

According to another aspect of the present invention, a non-transitory computer-readable medium storing thereon computer-readable instructions that, when executed cause a computer system to perform a method, as set forth above, for issuing an access authorization for a software product provided on an application server.

### BRIEF DESCRIPTION OF THE DRAWING

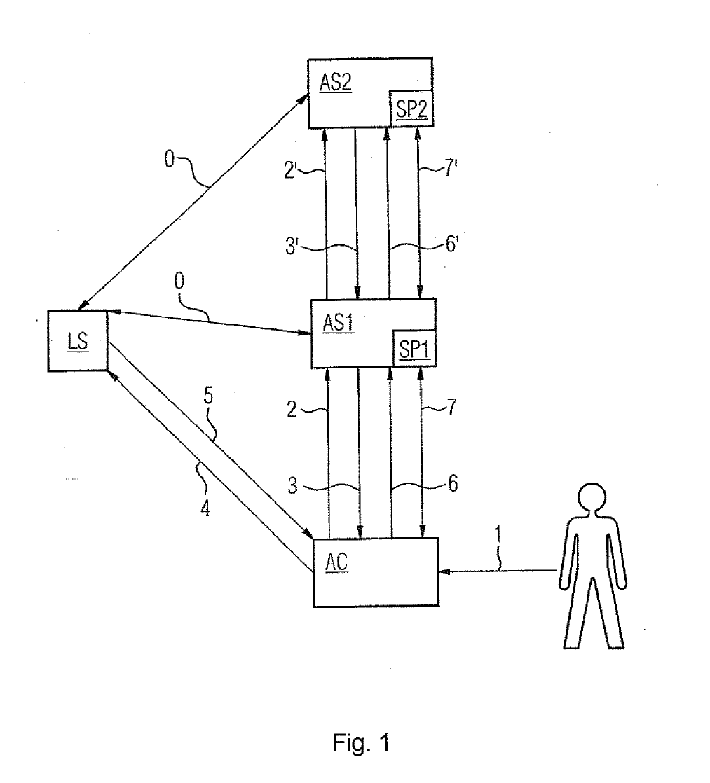

Other features and advantages of the present invention will be more readily apparent upon reading the following description of currently preferred exemplified embodiments of the invention with reference to the accompanying drawing, in which the sole FIG. 1 illustrates an access authorization process for a software product in accordance with the present invention.

### DETAILED DESCRIPTION OF PREFERRED EMBODIMENTS

The depicted embodiment is to be understood as illustrative of the invention and not as limiting in any way. It should also be understood that the figure is may not necessarily be to scale. In certain instances, details which are not necessary for an understanding of the present invention or which render other details difficult to perceive may have been omitted.

Turning now to FIG. 1, there is shown an exemplary access authorization process for a software product in accordance with the present invention. FIG. 1 shows a license server LS, an application client AC, a first application server AS1 and a second application server AS2, which can be or are connected to one another by way of a computer network. Software products SP1 or SP2 are provided on the application servers AS1 and AS2, for instance in the form of web services. In order to configure the indicated computer system, a trust relationship is firstly established between the license server LS and the two application servers AS1 and AS2. This is illustrated in FIG. 1 by the double arrows provided with the reference characters “0”. With the configuration, the application servers AS1 and AS2 obtain the public key (the public certificate), with which the license server electronically signs files and can thus subsequently check the authenticity of the license token signed by the license server.

In a first step 1, an authorized human user uses a function of the application client AC, for instance by user inputs, by means of a keyboard. Alternatively, it would also be conceivable, without intervention from a human user, for a software to use a function of the application client AC. The function renders a request for a software product (web services) SP1 provided on the first application server AS1 necessary (step 2). In a third step 3, the application server AS1 responds with a list of the required licenses and transmits data in this connection to the application client AC. In a fourth step 4, the application client AC requests data relating to the required licenses from the license server LS. The license server LS establishes a license token here, from which the license and thus the access rights of the application client AC emanate in respect of the software product SP1. This license token is signed electronically by the license server LS, in particular using its secret signature key and is transmitted in step 5 to the application client AC. A second request for the software product SP1 by the application client AC now takes place in step 6, wherein the electronically signed license token is supplied with this request. The first application server AS1 then checks the validity of the license listed in the license token by means of the public signature key of the license server LS If the required license is available, the access authorization on the software product SP1 is issued to the application client AC (step 7). After the configuration, no connection between the license server LS and the application server AS1 is thus required in order to check the license as a result of a request for the software product SP1.

If the software product requested by the application client AC is not available on the first application server AS1 which is directly connected to the application client AC, but instead on a second application server AS2, the indicated procedure can be extended as follows: If the first application server AS1 identifies that a second software product SP2 requested by the application client AC is not stored on the first application server AS1, but instead on the second application server AS2, this forwards the request originating from the application client AC in a step 2′ to the second application server AS2. In step 3′, this transfers information relating to the licenses required for the access to the first application server AS1 and the previously illustrated series of data transmissions takes its course until the established and electronically signed license token in step 6′ lands in the second application server AS2. This finally checks, by means of the public signature key of the license server LS, the validity of the transmitted license token and in the event of an existing license of the application client AC in respect of the software program SP2 allows access via the application server AS1 to the application server AS2 (steps 7 and 7′).

The procedure shown last for the case of two application serves AS1 and AS2 can naturally be extended analogously to any number of application servers.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for issuing an access authorization for a software product provided on an application server, comprising:
requesting a software product by an application client;
requesting at least one license required for access to the software product from the application client by the application server;
requesting a required license from a license server by the application client, establishing an electronically signed license token by the license server;
transferring the license token signed electronically by the license server to the application client;
transferring the electronically signed license token from the application client to the application server;
checking the license token transferred and electronically signed by the application server; and
in the presence of a valid license, issuing the access authorization for the access of the application client to the software product.

2. The method of claim 1, wherein the license server uses a secret signature key for the electronic signature of the license token and the application server verifies the license token through use of a public signature key of the license server.

3. The method of claim 2, wherein the public signature key together with the electronically signed license token is transmitted from the license server via the application client to the application server.

4. The method of claim 1,
wherein the application client directs a request for the software product to a first application server,
wherein the first application server forwards the request to a second application server on which the software product is provided,
wherein the second application server requests the license required for the access from the first application server,
wherein the first application server requests the required license from the application client,
wherein the application client transfers the signed license token to the first application server,
wherein the first application server transfers the signed license token to the second application server,
wherein the second application server checks the transferred electronically signed license token and issues the access authorization for the access to the software product to the application client in the presence of the valid license.

5. The method of claim 1, wherein a property relating to the license in the license token is contained in the license token.

6. The method of claim 5, wherein the property includes an expiry date or restriction of the license to a specific function of the software product.

7. The method of claim 1, further comprising establishing a trust relationship once with the application server and the license server.

8. The method of claim 4, further comprising establishing a trust relationship once with the first and second application servers and the license server.

9. The method of claim 1, wherein the software product is a web service.

10. A non-transitory computer-readable medium storing thereon computer-readable instructions that, when executed cause a computer system to perform a method for issuing an access authorization for a software product provided on an application server, said method comprising:
requesting a software product by an application client;
requesting at least one license required for access to the software product from the application client by the application server;
requesting a required license from a license server by the application client, establishing an electronically signed license token by the license server;
transferring the license token signed electronically by the license server to the application client;
transferring the electronically signed license token from the application client to the application server;
checking the license token transferred and electronically signed by the application server; and
in the presence of a valid license, issuing the access authorization for the access of the application client to the software product.

11. The computer-readable medium of claim 10, wherein the license server uses a secret signature key for the electronic signature of the license token and the application server verifies the license token through use of a public signature key of the license server.

12. The computer-readable medium of claim 11, wherein the public signature key together with the electronically signed license token is transmitted from the license server via the application client to the application server.

13. The computer-readable medium of claim 10,
wherein the application client directs a request for the software product to a first application server,
wherein the first application server forwards the request to a second application server on which the software product is provided,
wherein the second application server requests the license required for the access from the first application server,
wherein the first application server requests the required license from the application client,
wherein the application client transfers the signed license token to the first application server,
wherein the first application server transfers the signed license token to the second application server,
wherein the second application server checks the transferred electronically signed license token and issues the access authorization for the access to the software product to the application client in the presence of the valid license.

14. The computer-readable medium of claim 10, wherein a property relating to the license in the license token is contained in the license token.

15. The computer-readable medium of claim 14, wherein the property includes an expiry date or restriction of the license to a specific function of the software product.

16. The computer-readable medium of claim 10, further comprising establishing a trust relationship once with the application server and the license server.

17. The computer-readable medium of claim 13, further comprising establishing a trust relationship once with the first and second application servers and the license server.

18. The computer-readable medium of claim 10, wherein the software product is a web server.
